(19) United States
(12) Patent Application Publication
(10) Pub. No.: US 2022/0132868 A1
(43) Pub. Date: May 5, 2022

(54) GRANULAR FOOD INGREDIENT COMPRISING A MUCILAGINOUS HYDROCOLLOID, A MANNAN-BASED HYDROCOLLOID, EGG WHITE AND INSOLUBLE FIBRE

(71) Applicant: Lo-Dough Limited, Greater Manchester (GB)

(72) Inventors: Ben Holden, Cheshire (GB); Robert Wales, Greater Manchester (GB)

(21) Appl. No.: 17/432,874

(22) PCT Filed: Feb. 21, 2020
(86) PCT No.: PCT/GB2020/050411

§ 371 Date: Aug. 20, 2021

(30) Foreign Application Priority Data
Feb. 22, 2019 (GB) 1902447.0
Jul. 31, 2019 (GB) 1910912.3

(51) Int. Cl. A21D 10/00; A21D 2/26; A21D 13/062; A21D 13/068; A21D 2/36; A23L 29/238; A21D 2/18; A23L 33/21; A23L 33/19

(52) U.S. Cl. CPC A21D 10/005; A21D 2/262; A21D 13/062; A21D 13/068; A23L 33/19; A23L 29/238; A21D 2/181; A21D 2/183; A23L 33/21; A21D 2/36

(57) ABSTRACT

The present invention relates to a granular food ingredient, and a method for making a granular food ingredient. The granular food ingredient is low in carbohydrate and fat. The granular food ingredient can be used as the basis for manufacturing a variety of food products which are traditionally made using flour.

The present invention relates to a granular food ingredient, and a method for making a granular food ingredient. The invention also relates to a culinary mix comprising a granular food ingredient.

### BACKGROUND

Excess calorie intake has been linked to obesity and various diseases including diabetes. Additionally, obesity is often seen as unattractive amongst many Eastern and Western populations. For these reasons there is a need for food ingredients which have a reduced calorie content. Reduction in calorie content of a food product may be achieved by using ingredients that have a reduced fat content or reduced carbohydrate content to prepare the food product. More recently, since certain fats have been recognised as being important to a healthy lifestyle, low carbohydrate diets have become popular in order to reduce weight gain, lose excess weight and to maintain a healthy weight.

Carbohydrate based foods are an important component of the Western diet. Such food products are generally made from plain or wholemeal flour, yeast and water. Fat and sugar may also be added. Due to the carbohydrate content, such foods have a high calorie density, often reaching and even exceeding 500 kcal per 100 grams.

The prior art presented in patent application GB 1701907.6 provides low fat, low carbohydrate bakery products, such as breads, pastries, wraps, pizzas and other bread based products.

The present invention aims to provide an alternative food ingredient which overcomes or ameliorates problems associated with high carbohydrate and/or fat foods.

### BRIEF SUMMARY OF THE DISCLOSURE

In a first aspect, the invention provides a substantially dehydrated granular food ingredient comprising a mucilaginous hydrocolloid, a mannan-based hydrocolloid, egg white, insoluble fibre and water.

In a suitable embodiment of the first aspect, a substantially dehydrated granular food ingredient of the first aspect of the invention may comprise 1%-25% by weight of a mucilaginous hydrocolloid, 1%-25% by weight of a mannan-based hydrocolloid, 5%-50% by weight of egg white, 30%-90% by weight of insoluble fibre, and optionally 0.1%-10% by weight of water. Suitably, a substantially dehydrated granular food ingredient of the first aspect of the invention may comprise between 5%-40% by weight of a texture enhancer.

In a suitable embodiment of the first aspect of the invention, the egg white may be egg white in its natural liquid form, egg white powder, or egg white powder that is or has been reconstituted in water.

In a suitable embodiment, a granular food ingredient of the first aspect of the invention may have a granule or particle size of about 5 μm to 5 mm.

In a suitable embodiment of the first aspect of the invention, the granular food ingredient may be used as a flour substitute.

In a suitable embodiment of the first aspect of the invention, the granular food ingredient may be in the form of a crumb.

Suitably, the granular food ingredient of the first aspect of the invention may be used as a substitute for a bread crumb.

In a suitable embodiment of the first aspect of the invention the granular food ingredient is low in fat. In a suitable embodiment, the granular food ingredient of the first aspect may comprise less than 3% by weight of fat.

In a suitable embodiment, the granular food ingredient of the first aspect may comprise less than 15% carbohydrate.

In a suitable embodiment, the granular food ingredient of the first aspect may be sterilised.

In a suitable embodiment, the granular food ingredient of the first aspect may have a long shelf life.

In a suitable embodiment, the granular food ingredient of the first aspect may be packaged.

In a second aspect, the present invention provides a culinary mix comprising a granular food ingredient of the first aspect of the invention.

In a suitable embodiment, the granular food ingredient provided in the culinary mix of the second aspect may be as defined in the first aspect and in suitable embodiments thereof.

In a third aspect, the present invention provides a method of making a granular food ingredient, the method comprising the steps of:
i) mixing a mucilaginous hydrocolloid, a mannan-based hydrocolloid, insoluble fibre, and water to provide a first mixture;
ii) combining the first mixture with egg white to provide a liquid mixture;
iii) optionally, applying the liquid mixture onto a baking sheet;
iv) drying the mixture to remove water and provide a substantially dehydrated food product and
v) grinding the substantially dehydrated food product of step iv) to create a granular food ingredient.

Suitably, a method according to the third aspect of the invention may produce a substantially dehydrated granular food ingredient of the first aspect of the invention.

Suitably, a method of the third aspect does not comprise rehydrating the substantially dehydrated food product prior to grinding.

In a suitable embodiment, the method of the third aspect may further comprise the step of sterilising and/or packaging the food ingredient.

In a suitable embodiment of the third aspect of the invention, the egg white may be an egg white powder, or an egg white powder that is reconstituted in water.

### DETAILED DESCRIPTION

The present invention is based on the surprising finding that a composition comprising a mucilaginous hydrocolloid, a mannan-based hydrocolloid, a binding agent, insoluble fibre, and water may be used to form a food ingredient. The food ingredient is in a granular form that can be used as the basis for manufacturing a variety of food products which are traditionally made using flour.

The inventors have surprisingly found that the granular food ingredients of the first aspect of the invention can be used as a low fat, low carbohydrate and/or low calorie alternative to traditional food ingredients such as flour or breadcrumbs. The food ingredient of the invention may be used in a variety of foods such as breads, brownies, cakes and pastries to provide a low fat, low carbohydrate and/or low calorie alternative to foods that are traditionally made using flour

Additionally, the inventors have surprisingly found that the food ingredient of the invention may be able to withstand a sterilisation process (for example sterilisation by retort), allowing the ingredient to have a long shelf life. In addition, the substantially dehydrated nature of the food ingredient also offers the advantage of a longer shelf life than freshly prepared or ready-made food products. This offers an advantage of less food products being wasted.

Additionally, providing a granular food ingredient offers an advantage in terms of supply chain and transportation compared to prepared or ready-made food products. Dry bulk ingredients are easier to transport and use less physical space than prepared foods offering an advantage to supply chain. This is particularly relevant to the health food market and food manufacturing industry.

### DEFINITIONS

The term “food ingredient” as used herein, is an edible substance which is generally not eaten alone but may be used to make food, by combination with one or more other ingredients. Other ingredients include for example sugar, egg, water, milk, flavourings, fat such as butter, lard or oil, meat, vegetables, fruit, cheese, soya, lentils, pulses, and beans etc. A food ingredient of the present invention when combined with one or more other food ingredients may form a homogenous mixture, such that the food ingredient of the invention is not distinguishable from the other ingredients of the mixture. Alternatively or additionally, a food ingredient of the present invention may be used as a coating, topping or filling on or in a food. In such an embodiment, a food ingredient of the invention is distinguishable, or separate (i.e. not homogenous) from one or more other food ingredients making up the food. In the context of the present invention, the term “food ingredient” encompasses a granular food ingredient of the first aspect of the invention. The culinary mix of the second aspect of the invention may comprise a food ingredient of the first aspect of the invention. The term “food ingredient” may refer to a food ingredient which is substantially gluten free.

A food ingredient of the invention may comprise at least 70%, 75%, 80%, 85%, 90%, 91%, 92%, 93%, 94%, 95%, 96%, 97%, 98%, or at least 99% by weight of a combination of a mucilaginous hydrocolloid, mannan-based hydrocolloid, insoluble fibre, binding agent, water and optionally a texture enhancer. Suitably, the food ingredient may comprise at least 90%, preferably between 90% and 95% by weight of a combination of a mucilaginous hydrocolloid, mannan-based hydrocolloid, insoluble fibre, binding agent, water and optionally a texture enhancer.

A food ingredient of the invention may be a low carbohydrate product. The term “carbohydrate” refers to a carbohydrate which is digestible and/or absorbable by humans. Accordingly, carbohydrates derived from fibres which may not be digested or absorbed by humans are not encompassed by the term “carbohydrate” in this specification. The “carbohydrate” content of the food product may be substantially derived from a mucilaginous hydrocolloid. By “low carbohydrate” it is meant that the food ingredient has a carbohydrate content of 15, 14, 13, 12, 11, 10, 9, 8, 7, 6, 5, 4, 3, 2, or 1 gram(s) or less per 100 grams of food product. Suitably, the food product has a carbohydrate content of 1.0, 0.75, 0.5, or 0.3 grams or less per 100 grams of food ingredient. Suitably, a food ingredient of the invention may have a carbohydrate content of 1 gram or less, 0.5 grams or less or 0.3 grams or less per 100 grams.

The food ingredient of the invention may be a low calorie ingredient. A calorie as used herein is an approximate amount of energy needed to raise the temperature of one gram of water by one degree Celsius at a pressure of one atmosphere. A kilocalorie (kcal) is 1000 calories. By “low calorie” it is meant that the food ingredient may have a calorie content of less than 300, 250, 150, 100, 90, 80, 70, 60, or 50 kcal per 100 grams. Suitably, the food ingredient may have a calorie content of 250 kcal per 100 grams or less, or 80 kcal per 100 grams or less.

The food ingredient of the invention may be a low fat ingredient. By “low fat” it is meant that the food product has a fat content of less than 3, 2.8, 2.6, 2.4, 2.2, 2, 1.8, 1.6, 1.4, 1.2, 1, 0.8, 0.6, 0.4, or 0.2 grams of fat per 100 grams. In other terms, it can be said the food ingredient of the invention comprises less than 3%, 2.8%, 2.6%, 2.4%, 2.2%, 2%, 1.8%, 1.6%, 1.4%, 1.2%, 1%, 0.8%, 0.6%, 0.4%, or 0.2% by weight of fat. Suitably, the food ingredient of the invention may be substantially fat free. By “substantially fat free” it is meant that the fat content of the food ingredient of the invention is less than 0.1 grams of fat per 100 grams, i.e. it comprises less than 0.1% by weight of fat. The term “fat” refers to triglyceride molecules naturally found within the ingredients described herein, from which the food ingredient of the first aspect of the invention are made from.

The food ingredient of the invention may be a high fibre product. By “high fibre” it is meant that the food ingredient has a fibre content of at least 3, 3.2, 3.4, 3.6, 3.8, 4, 4.2, 4.4, 4.6, 4.8, 5, 5.2, 5.4, 5.6, 5.8, 6 or more grams of fibre per 100 grams of fibre per 100 grams. It will be appreciated the fibre content may be derived not only from the insoluble fibre, but also from the mucilaginous hydrocolloid (such as psyllium), the mannan-based hydrocolloid (for example konjac), and/or a texture enhancer (for example hydroxypropylmethylcellulose), if such a texture enhancer is present.

A food ingredient of the invention may be suitable for consumption by humans (adults and/or children). Suitably, a food product of the invention intended for human consumption may not include food products intended for animal consumption, for example non-human animals such as farm animals (such as cows, sheep, goats, etc) or domestic animals (such as cats and dogs). Suitably, a food product of the invention for human consumption may therefore exclude food items such as animal dry meals, biscuits and treats.

The term “granular” as used herein refers to a food ingredient that is made up of a population of small particles, or grains, such that it may be or have the appearance of a powder, flour, granules, or breadcrumb. Particles may be referred to as fine or coarse particles. A granular food ingredient may be described as being powdery, grainy, floury, sandy or crumbled. A suitable granular food ingredient may be a powder that in its consistency resembles flour. In another embodiment, a granular food ingredient of the invention may have a consistency which resembles sugar, for example caster sugar or granulated sugar. In another embodiment, a granular food ingredient of the invention may have a consistency which resembles gravy granules. In another embodiment, a suitable granular food ingredient of the invention may have a consistency the resembles breadcrumbs.

A granular food ingredient of the invention may comprise granules that range from fine to coarse, such as a flour to a breadcrumb. By way of example, a granular food ingredient may comprise granules that are about 5 μm to 5 mm in diameter, more suitably 10 μm to 4 mm, more suitably 100 μm to 4 mm, more suitably 300 μm to 4 mm; more suitably 500 μm to 4 mm; more suitably 700 μm to 4 mm; more suitably 1 mm to 4 mm; more suitably 1 mm to 3 mm. In a suitable embodiment, a granular food ingredient of the invention may comprise granules that are about 5-50 μm in diameter, 50-100 μm in diameter, 100-200 μm in diameter, 200-300 μm in diameter, 300-400 μm in diameter, 400-500 μm in diameter, 500-600 μm, 600-700 μm, 700-800 μm, 800-900 μm or 900-1000 μm. Suitably, a granular food ingredient of the invention may comprise granules that are about 1-2 mm in diameter, 2-3 mm in diameter, 3-4 mm in diameter or 4-5 mm in diameter.

In a suitable embodiment, a granular food ingredient may comprise a population of particles that are a range of sizes. Suitably, a granular food ingredient of the present invention may comprise a population of particles that are 90% substantially the same size, that are 80% substantially the same size, 70% substantially the same size, 60% substantially the same size, 50% substantially the same size, 40% substantially the same size, 30% substantially the same size, 20% substantially the same size, 10% substantially the same size. Suitably, substantially all the particles in a portion of a food ingredient of the present invention may have substantially the same size. By substantially is meant at least 70%, at least 80%, at least 90%, or at least 95%, 96%, 97%, 98% or 99% of the particles having the same size. By the same size is meant within 10% larger or smaller than a particular range or size. It will be appreciated that a granular food ingredient of the invention may comprise granules of a range of sizes.

It will be appreciated that the skilled person would use the appropriate machinery and time period of grinding to achieve a granular food ingredient having the desired granule size.

Suitably, a granular food ingredient of the invention may be used as a substitute for food ingredients such as flour, starch, rusk, filler, bread crumbs, coatings. Thus, the food ingredient of the invention may be used as a substitute for a food ingredient which conventionally comprises gluten. The food ingredient of the invention may be used to make food products which conventionally contain flour, and/or starch. Thus, food products which traditionally contain flour or starch may be made by replacing the flour or starch with a food ingredient of the present invention, and are included within the scope of the present invention. Such food products include but are not limited to breads or bread crumbs, coatings, cakes, brownies, pancakes, waffles or pastries.

The term “dehydrated food ingredient” refers to a food ingredient which substantially does not comprise water. By substantially dehydrated is meant that it is either completely dehydrated so that the water content is zero, or that it contains a residual water content after baking. The substantially dehydrated food ingredient of the invention may comprise 15% or less of water, more suitably 10% or less, more suitably 6% or less. The substantially dehydrated food ingredient of the invention may be used as a substitute for flour, or starch. Therefore, a substantially dehydrated food ingredient of the present invention may be similar, or substantially the same, in terms of texture and/or taste to a conventional dried food ingredient such as flour or starch.

The term “mucilaginous hydrocolloid” refers to a hydrocolloid substance comprising polymers of one or more monosaccharides, which when exposed to a fluid (such as water) forms a slimy mass. By way of example, a mucilaginous hydrocolloid may be obtained from a plant, in particular from a seed of a plant, in particular from a seed husk. Suitable mucilaginous hydrocolloids may include psyllium, linseed (also known as flaxseed), and chia seed. In certain embodiments, a mucilaginous hydrocolloid may also be used as a “binding agent”. Suitably, a mucilaginous hydrocolloid that may also be used as a binding agent is linseed or chai seed. Where a mucilaginous hydrocolloid is used as a binding agent, it may be the same or different to the mucilaginous hydrocolloid which forms 0.1 to 25% of the food ingredient.

The term “psyllium” as used herein, refers to the seed from plants of the Plantago genus. Suitable seeds may be obtained from various Plantago species, including without limitation P. laceolate, P. rugelii and P. major. Other suitable species will be known to the person skilled in the art. Reference to psyllium includes intact whole seeds and/or milled seeds, and intact or milled seed husks. Milled seeds or husks may of any suitable degree of coarseness, for example a rough or a fine powder.

The term “mannan-based hydrocolloid” refers to a hydrocolloid substance comprising a mannan, in particular a glucomannan and/or a galactomannan. A mannan-based hydrocolloid may suitably be high in mannan content, for example comprise at least 30% by weight of mannan. An example of a hydrocolloid substance high in glucomannan is konjac. Examples of hydrocolloids high in galactomannan include locust bean gum, guar gum, carob tree, carob bean gum, senna gum, tara gum and fenugreek gum. Other suitable mannan-based hydrocolloids which may be used in the present invention will be known to the skilled person.

For the purpose of the present invention, xanthum gum is not considered to be a mannan based hydrocolloid or plant derived hydrocolloid. In a suitable embodiment, a food product, ingredient, liquid mixture does not comprise xanthan gum as the mannan based hydrocolloid. Therefore if xanthum gum is present, it may be present at less than 0.5%, or suitably less than the defined percentage of mannan based hydrocolloid. In a suitable embodiment, a food product, ingredient, or liquid mixture of the invention does not comprise xanthan gum.

The term “konjac” as used herein, refers to a plant of the genus Amorphophallus. Suitably “konjac” may refer to the tubers of the Amorphophallus plant. Preferably, the tubers may be ground. Suitably ground tubers may be in the form of konjac flour.

The term “egg protein” as used herein refers to the albumin protein and other proteins found within the egg white. It will be appreciated that the egg white, which is comprised of approximately 90% of water, is converted to egg protein during the process of heating, which removes the water content from the liquid mixture.

The term “egg white” as used herein refers to raw albumen. In one embodiment, the raw albumen may be directly obtained from an edible egg, such as an egg from a hen, turkey, duck, goose or pheasant. Egg white may be obtained from egg white powder reconstituted in a suitable liquid, such as water. The use of egg white powder reconstituted in water may be preferred due to its ability to make a food ingredient with an improved (e.g. brighter, or increased whiteness) appearance than may be achieved when using egg white obtained directly from an edible egg in the invention.

The term “water” as used herein refers to pure water as well as a water based liquid. A water based liquid may comprise at least 70%, 75%, 80%, 85%, 90%, 95%, or at least 99% water. A water based liquid may comprise food enhancers. Examples of suitable food enhancers are described herein.

The term “insoluble fibre” as used herein, refers to fibre which is essentially insoluble in water. In the context of the present invention, suitable insoluble fibre may be selected from the group consisting of: wheat fibre, oat fibre, cellulose, hemicellulose and lignin, or a combination thereof. Preferably, the insoluble fibre is wheat fibre.

The term “texture enhancer” as used herein, refers to a substance which has the effect of changing the texture of a food ingredient, for example by increasing or decreasing any aspect of texture. This may include the texture of the food ingredient, such as the granularity of a granular food ingredient, or the viscosity of a liquid food ingredient. A texture enhancer may be added to a food ingredient or a culinary mix to enhance the texture of a food product that is made using the food ingredient, including for example the elasticity, density, shape formation and retention, softness, binding, stretchiness, stability of a food, which would have a different texture in the absence of the enhancer. A texture enhancer may suitably serve to increase the similarity between a food ingredient of the invention and a conventional food ingredient. Suitably, a granular food ingredient of the present invention may comprise a texture enhancer to increase similarity with flour or starch. A texture enhancer is typically an additive rather than a food ingredient. Suitable texture enhancers for use in the present invention may include those which in the presence of a liquid, such as water, increases softness, elasticity and/or stretchiness of a food that is made using the food ingredients of the invention compared to the softness, elasticity and/or stretchiness of a food made using ingredient in the absence of the texture enhancer. Suitable texture enhancers for use in the present invention will be known to persons skilled in the art, and include for example those which are commonly used as gluten substitutes. By way of example, a texture enhancer may be selected from the group consisting of a cellulose derivative, a gum (such as carrageenan and xanthan gum) and or a starch (such as arrowroot, corn starch and potato starch).

The term “cellulose derivative” refers to a substance obtained by a chemical modification of cellulose. In the context of the present invention, a particularly useful cellulose derivative is hydroxypropylmethylcellulose (HPMC). Other types of cellulose derivatives will be known to the skilled person. Merely by way of example, these may include arboxymethylcellulose, methylcellulose, and hydroxypropyl cellulose.

The term “grinding” refers to a process of converting a product, such as a food product produced in steps i) to iv) of the sixth and seventh aspects of the invention, into a population of small particles or grains. Grinding typically involves pulverising a food product by abrasion or friction to produce a food ingredient with a granular appearance. The term “grinding” may also include processes such as a milling, blending, pulverising, breaking, mincing, grating, shredding or crumbling.

The term “culinary mix” refers to two or more ingredients for making a food, wherein one or more of the ingredients is a food ingredient of the invention. The culinary mix may comprise other food ingredients, such as sugar, cocoa, flavouring, colouring, fats, baking powder, salt or egg. A culinary mix of the invention may comprise two or more food ingredients in a single pack. A culinary mix may comprise two or more food ingredients in separate packaging. A culinary mix may comprise all of the ingredients or some of the ingredients required to make a food. Suitably, a culinary mix may be added to staple food products, such as milk, butter, oil to make a food product. Suitably, a culinary mix of the present invention may be used to make a food such as bread or bread crumbs, coatings, batters, cakes, brownies, pancakes, waffles or pastries. A culinary mix may also comprise toppings, fillings, coatings, and/or decorations. The present invention also provides a kit comprising a culinary mix of the present invention and one or more non-edible components such as an instructions leaflet, a cup cake case, a spatula, measuring spoon, or non-edible decorations.

In the context of the present invention, egg white powder may be reconstituted in a liquid at a ratio of between 5 and 30% of egg white powder: between 95% and 70% liquid, respectively; more suitably between 10 and 20% of egg white powder: between 90% and 80% of liquid, respectively; most suitably approximately 12.5% of egg white powder: approximately 87.5% of water. Therefore, in such an embodiment, 100 grams of egg white is obtained from 12.5 grams of egg white powder and 87.5 grams of water.

In the present specification, when reference is made to the percentage of egg white in the liquid mixture, this is based on an egg white obtained directly from an egg, or an egg white obtained from egg white power reconstituted in water at a concentration of 12.5% of egg white powder and 87.5% of water. However, the skilled person will appreciate that if these concentrations are altered, the amount of water used to make liquid mixture may require adjustment accordingly to yield a ingredient having the proportions defined herein. For example, if the egg white comprises more than 12.5% egg white powder, the amount of water to make the liquid mixture may be proportionally increased. By the same token, if the egg white comprises less than 12.5% egg white powder, the amount of water to make the liquid mixture may be proportionally decreased.

It will be appreciated that when reference is made to the percentage of water in a food ingredient of the first aspect of the invention the percentage does not include the water which may be derived from egg white, and/or used to reconstitute egg white powder.

It will be appreciated that when reference is made to the percentage of water in a food ingredient of the first aspect of the invention the percentage does not include the water which may be derived from a binding agent, and/or used to reconstitute binding agent powder.

The term “packaged” in the context of the present invention refers to a food ingredient of the present invention that is provided in packaging. Packaging may include primary packaging, referring to the layer of packaging in immediate contact with the food ingredient or culinary mix of the invention. Packaging may also include secondary or tertiary packaging, referring to additionally packaging in which primary packaging is contained. The food ingredients of the present invention may be provided in a range of portion sizes. Suitably, the food ingredient of the present invention may be provided in portion sizes that is suitable for consumer use, commercial scale use, and/or manufacturing scale use. Suitably, the culinary mix of the second aspect of the invention may be provided in one or more packs. Suitably, a food ingredient or culinary mix of the present invention may be sterilised whilst in its packaging. Suitably, a food ingredient or culinary mix of the present invention may be sterilised before it is packaged. Suitably, a portion sized packaging may comprise a granular food ingredient of the first aspect of invention in a quantity that is sufficient to make at least one serving of food. Suitably, a portion sized packaging may comprise a granular food ingredient of the first aspect of invention in a quantity that is sufficient to make at least one serving of coating or filling. Suitably, the size of a portion size pack may depend on the desired product. Suitably, a portion sized pack of a granular food ingredient of the first aspect of the invention may be between 50 g to 1 kg in weight. Suitably, a portion sized pack of a culinary mix of the second aspect of the invention may be between 50 g to 1 kg in weight. Merely by way of example, a portion sized pack of a culinary mix suitable to make brownies and/or cake may be approximately between 50 and 100 g, approximately between 100 and 200 g, approximately between 200 g and 300 g, approximately between 300 g and 400 g, approximately between 400 g and 500 g, approximately between 500 g and 600 g, approximately between 600 g and 700 g, approximately between 700 g and 800 g, approximately between 800 g and 900 g, approximately between 900 g and 1000 g.

A substantially dehydrated granular food ingredient of the first aspect of the invention may comprise at least 1%, 1.5%, 2%, 2.5%, 3%, 3.5%, 4%, 4.5%, 5%, 6%, 7%, 8%, 9%, 10%, 11%, 12%, 13%, 14%, 15%, 20%, or at least 25% by weight of a mucilaginous hydrocolloid. Preferably, the substantially dehydrated food ingredient may comprise at least 3.5% by weight, of a mucilaginous hydrocolloid, suitably between 3% and 10% by weight, of a mucilaginous hydrocolloid. Preferably, the substantially dehydrated food ingredient may comprise at least 3% by weight, of a mucilaginous hydrocolloid, suitably between 3% and 7% by weight, of a mucilaginous hydrocolloid. Preferably the mucilaginous hydrocolloid is psyllium.

A substantially dehydrated granular food ingredient of the first aspect of the invention may comprise at least 1%, 1.5%, 2%, 2.5%, 3%, 3.5%, 4%, 4.5%, 5%, 6%, 7%, 8%, 9%, 10%, 11%, 12%, 13%, 14%, 15%, 20%, or at least 25% by weight of a mannan-based hydrocolloid. Preferably, the substantially dehydrated food ingredient may comprise at least 3.5% by weight, of a mannan-based hydrocolloid, suitably between 3% and 10% by weight, of a mannan-based hydrocolloid. Preferably, the substantially dehydrated food ingredient may comprise at least 3% by weight, of a mannan-based hydrocolloid, suitably between 3% and 7% by weight, of a mannan-based hydrocolloid. Preferably the mannan-based hydrocolloid is konjac.

A substantially dehydrated granular food ingredient of the first aspect of the invention may comprise at least 5%, 6%, 7%, 8%, 9%, 10%, 11%, 12%, 13%, 14%, 15%, 16%, 17%, 18%, 19%, 20%, 21%, 22%, 23%, 24%, 25%, 30%, 32%, 35%, 40%, 45%, or at least 50% by weight, of egg protein. Preferably, the substantially dehydrated granular food may comprise at least 15% by weight, of egg protein, suitably between 15% and 25% by weight, of egg protein. Preferably, the substantially dehydrated granular food may comprise at least 15% by weight, of egg protein, suitably between 15% and 20% by weight, of egg protein.

A substantially dehydrated granular food ingredient of the first aspect of the invention may comprise at least 30%, 35%, 40%, 45%, 50%, 55%, 60%, 61%, 62%, 63%, 64%, 65%, 66%, 67%, 68%, 69%, 70%, 75% or at least 80% by weight, of insoluble fibre. Preferably, the substantially dehydrated food ingredient may comprise at least 40% by weight, of insoluble fibre, suitably between 40% and 50% by weight, of insoluble fibre. Preferably the insoluble fibre is wheat fibre.

A substantially dehydrated granular food ingredient of the first aspect of the invention may comprise at least 5%, 10%, 11%, 12%, 13%, 14%, 15%, 16%, 17%, 18%, 19%, 20%, 25%, 30%, 35%, or at least 40% by weight, of a texture enhancer. Preferably, the substantially dehydrated food may comprise at least 10% by weight, of a texture enhancer, suitably between 10% and 20% by weight, of a texture enhancer. Preferably, the substantially dehydrated food ingredient may comprise at least 10% by weight, of a texture enhancer, suitably between 10% and 20% by weight, of a texture enhancer. Preferably the texture enhancer is HPMC.

A substantially dehydrated granular food ingredient of the first aspect of the invention may comprise 15%, 14%, 13%, 12%, 11%, 10%, 9%, 8%, 7%, 6%, 5%, 4%, 3%, 2%, 1%, 0.5% or less, or 0.1% or less by weight of water. Preferably, the substantially dehydrated food ingredient may comprise 8% or less by weight of water.

In an embodiment of the first aspect of the invention, a substantially dehydrated granular food ingredient, may comprise between 1% and 25% by weight of a mucilaginous hydrocolloid, 1% and 25% by weight of a mannan-based hydrocolloid, between 5% and 50% by weight of egg protein, between 30% and 80% by weight of insoluble fibre, and optionally between 5% and 40% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

Preferably, a substantially dehydrated food ingredient of the first aspect of the invention may comprise between 3% and 10% by weight of a mucilaginous hydrocolloid, 3% and 10% by weight of a mannan-based hydrocolloid, between 15% and 25% by weight of egg protein, between 40% and 50% by weight of insoluble fibre, and optionally between 10% and 20% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

Preferably, a substantially dehydrated food ingredient of the first aspect of the invention may comprise between 3% and 8% by weight of a mucilaginous hydrocolloid, 3% and 8% by weight of a mannan-based hydrocolloid, between 10% and 20% by weight of egg protein, between 40% and 50% by weight of insoluble fibre, and optionally between 10% and 20% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

Preferably, the dehydrated food product may comprise between 3.5% and 10% by weight of a mucilaginous hydrocolloid, 3.5% and 10% by weight of a mannan-based hydrocolloid, between 25% and 35% by weight of egg protein, between 40% and 50% by weight of insoluble fibre, and optionally between 10% and 15% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

In a suitable embodiment, the dehydrated food product may comprise approximately 3.5% by weight of a mucilaginous hydrocolloid, approximately 3.5% by weight of a mannan-based hydrocolloid, approximately 32% by weight of egg protein, approximately 40% by weight of insoluble fibre, and optionally approximately 12% by weight of a texture enhancer. Preferably the mucilaginous hydrocolloid is psyllium. Preferably the mannan-based hydrocolloid is konjac. Preferably the insoluble fibre is wheat fibre. Preferably the texture enhancer is HPMC.

In a suitable embodiment, a substantially dehydrated food ingredient of the first aspect of the invention may comprise approximately 4.5% by weight of a mucilaginous hydrocolloid, approximately 4.5% by weight of a mannan-based hydrocolloid, approximately 18% by weight of egg protein, approximately 48% by weight of insoluble fibre, and optionally approximately 15% by weight of a texture enhancer. The ingredient may comprise approximately 5.5% water. The ingredient may comprise approximately 3% flavouring, such as salt. Preferably the mucilaginous hydrocolloid is psyllium. Preferably the mannan-based hydrocolloid is konjac. Preferably the insoluble fibre is wheat fibre. Preferably the texture enhancer is HPMC.

It will be appreciated that the final percent weight of a mucilaginous hydrocolloid, mannan-based hydrocolloid, insoluble fibre, binding agent and, if present, a texture enhancer in a granular food ingredient according to the first aspect of the invention may ultimately depend on the amount of water removed from during heating.

Merely by way of example, a substantially dehydrated food ingredient may comprise 99% by weight of a mucilaginous hydrocolloid, mannan-based hydrocolloid, insoluble fibre, binding agent and, if present, a texture enhancer.

A food ingredient of the invention may comprise a food enhancer. Suitably, a food ingredient of the invention may comprise less than 10%, 9%, 8%, 7%, 6%, 5%, 4%, 3%, 2%, or less than 1% by weight, of a food enhancer.

Suitable food enhancers may enhance the taste, mouthfeel, appearance and/or longevity of the food ingredient. In one embodiment, an enhancer may enhance one or more of these.

For example, food enhancers that enhance the taste of the food ingredient may be selected from the group consisting of: food acids (for example citric acid), natural flavour (for example salt, pepper, and garlic powder), artificial flavours (for example monosodium glutamate, potassium bromate, potassium sorbate, and vanillan), condiments (for example salt and paper) and sweeteners (for example stevia, agave syrup, aspartame, high-fructose corn syrup, saccharin, sucralose and sugar alcohol, or any combination thereof. Other suitable food enhancers that enhance the taste of the food ingredients will be known by the skilled person.

Food enhancers that enhance the mouthfeel of the food ingredients, may be selected from the group consisting: emulsifiers (for example oils and fat), humectants (for example sorbitol, glycerol, and propylene glycol), or a combination thereof. Other food enhancers that enhance the mouthfeel of the food ingredient will be apparent to the skilled person.

Food enhancers that enhance the appearance of the food ingredient may be selected from the group consisting of: food colouring (for example artificial and natural food dyes), colour retention agents (for example ascorbic acid) and glazing agents (for example propylene glycol, eggin, dimethylpolysiloxane, beeswax, candelilla wax and carnauba wax), or any combination thereof. Other food enhancers that enhance the appearance of the food ingredient will be apparent to the skilled person.

Food enhancers that enhance the longevity of the food ingredient of the invention may be selected from the group consisting of: stabilizers (for example alginic acid, gelatin and lecithin), preservatives (for example propionic acid and sodium propionate) and antioxidants (for example ascorbic acid, butylated hydroxytoluene, and butylated hydroxyanisole), or any combination thereof. Other food enhancers that enhance the longevity of the food ingredient will also be apparent to the skilled person.

Preferably, the food ingredient of the first aspect of the invention may comprise less than 2%, or less than 1% by weight of a food enhancer. Preferably, the food enhancer is a taste enhancer, preferably the taste enhancer is salt.

Preferably, the substantially dehydrated food ingredient of the second or third aspect of the invention may comprise less than 5% by weight of a food enhancer. Preferably, the food enhancer is a taste enhancer, preferably the taste enhancer is salt.

Preferably, the liquid food ingredient of the fourth aspect of the invention may comprise less than 5% by weight of a food enhancer. Preferably, the food enhancer is a taste enhancer, preferably the taste enhancer is salt.

It will be appreciated that the granular food ingredient of the first aspect may comprise other suitable ingredients. When the food ingredient of the invention comprises other such ingredients, the skilled person will be able to adjust the above mentioned proportions (for example based on the ranges of suitable proportions disclosed elsewhere within this specification) to obtain a granular food ingredient or a liquid food ingredient of the invention.

In a second aspect, the present invention provides a culinary mix comprising two or more ingredients for making a food, wherein one or more of the ingredients is a food ingredient of the invention. A culinary mix may comprise other food ingredients, such as sugar, artificial sweetener, cocoa, flavouring, colouring, fats, baking powder, salt or egg.

In a suitable embodiment a culinary mix of the second aspect of the invention may provide ingredients required to make a brownie. Suitably, such a culinary mix may comprise up to 10%, 20%, 30%, 40%, 50%, 60%, 70% or 80% of a granular food ingredient of the first aspect of the invention.

In a suitable embodiment, a culinary mix of the present invention comprises a food ingredient of the first aspect, a natural or artificial sweetener, a binding agent and fibre, suitably wheat. The food ingredient of the first aspect may suitably be a fine crumb or a flour.

Suitably, the culinary mix may comprise about 50-60% sweetener, 30-45% a food ingredient of the first aspect, 15-25% binding agent, and 3-10% wheat. Suitably, the ingredient of the first aspect is a fine crumb or a flour.

Suitably in such culinary mix may also comprise flavourings, a gelling agent, preservatives, colourings. These ingredients may be 10% or less of the culinary mix.

Suitably, the culinary mix is for preparing a brownie or a cake, and comprises: about 50-60% sweetener; about 18-23% food ingredient of the first aspect; about 8-12% egg white; about 4-8% wheat; and about 4-8% flavourings, colouring, preservatives and/or gelling agents etc in suitable amounts.

In a third aspect, the present invention provides a method of making a granular food ingredient, the method comprising the steps of:
i) mixing a mucilaginous hydrocolloid, a mannan-based hydrocolloid, insoluble fibre, and water to provide a first mixture;
ii) combining the first mixture with egg white to provide a liquid mixture;
iii) optionally, applying the liquid mixture onto a baking sheet;
iv) drying the mixture to remove water and provide a substantially dehydrated food product and
v) grinding the product of step iv) to create a substantially dehydrated granular food ingredient.

The method may be a method for making a substantially dehydrated granular food ingredient of the first aspect of the invention. The method comprises i) mixing a mucilaginous hydrocolloid, a mannan-based hydrocolloid, insoluble fibre, water and optionally a texture enhancer to provide a first mixture; and ii) combining the first mixture with egg white to provide a liquid mixture. The egg white may be whisked prior to being combined with the liquid mixture.

The term “whisked” or “whisking” as used herein, refers to any form of mixing which serves to aerate the egg white. Suitably whisking may result in the formation of a foam from the egg whites. Suitably, the egg white, before being combined with the first mixture, may be whisked until stiff peaks are formed. The term “stiff peaks” refers to the texture of the egg white foam and can be identified by the formation of peaks in the foam which are maintained despite removal of the whisking implement or movement/upturning of the container in which whisking is performed. In an embodiment, the egg white may be whisked prior to or after the mixing of step i) or simultaneously with the mixing of step i). Whisking of the egg white may continue for any suitable period of time until a foam, and preferably stiff peaks are formed. This may be between 10 and 120 seconds. Preferably, whisking maybe for approximately 60 seconds. The timings used may vary in a commercial scale kitchen or manufacturing facility.

In a suitable embodiment, steps i) and ii) of the third aspect of the invention may be combined into a single step. In such an embodiment the mucilaginous hydrocolloid, the mannan-based hydrocolloid, insoluble fibre, water and egg white are all mixed together to provide the liquid mixture of step ii).

In both the embodiments of the third aspect relating to separate steps i) and ii) or a combined steps i) and ii) the egg white may be provided in the form of raw albumen from an edible egg, or in the form of egg white powder. Egg white powder may be reconstituted prior to its combination with other ingredients, or may be reconstituted during process with liquid (e.g. water) provide in a mixture. Therefore, in an embodiment where steps i) and ii) are separate, egg white powder may be reconstituted prior to step ii). Alternatively, the egg white powder may be reconstituted during step ii), for example using liquid (e.g. water) present in the first mixture, or liquid (e.g. water) which may be added during step ii). Therefore, step ii) may comprise combining the first mixture with reconstituted egg white powder to provide a liquid mixture; or combining the first mixture with egg white powder to provide a liquid mixture; or combining the first mixture with egg white powder and a suitable liquid (e.g. water) to provide a liquid mixture of step ii).

Accordingly, in one embodiment, the invention provides a method of making a substantially dehydrated food ingredient, the method comprising the steps of:
i) mixing a mucilaginous hydrocolloid, a mannan-based hydrocolloid, insoluble fibre, egg white and water to provide a liquid mixture;
ii) optionally, applying the liquid mixture onto a baking sheet;
iii) drying the mixture to remove water and provide a substantially dehydrated food product and
iv) grinding the substantially dehydrated food product of step iv) to create a substantially dehydrated granular food ingredient.

It will be appreciated that when a mucilaginous hydrocolloid, a mannan-based hydrocolloid, insoluble fibre, egg white and water are mixed to provide a first mixture, the egg white may be obtained from egg white powder which has been reconstituted prior to step i), or which is reconstituted in a suitable liquid (e.g. water) during the step of mixing.

It will also be appreciated that when the substantially dehydrated food ingredient of the third aspect of the invention may comprise a texture enhancer, this may be obtained according to the method of the third aspect of the invention, where step i) involves mixing a mucilaginous hydrocolloid, mannan-based hydrocolloid, insoluble fibre, water and the texture enhancer. Where step i) and step ii) of the method of the invention are combined into a single step, a mucilaginous hydrocolloid, mannan-based hydrocolloid, insoluble fibre, egg white and water, and optionally the texture enhancer may be mixed together.

The method of the third aspect of the invention comprises a step of grinding a food ingredient to produce a granular food ingredient of the first aspect of the invention. As described elsewhere in the specification, the term “grinding” refers to a process of converting one or more larger products into a population of small particles or grains. Grinding typically involves pulverising (i.e. breaking down) a food product by abrasion or friction to produce a food ingredient with a granular consistency. In the context of the present invention, grinding may include, but is not limited to, milling, blending, pulverising, breaking, mincing, grating, shredding or crumbling. Grinding may be achieved using specific tools and/or machinery. Such tools and machinery would be known to the skilled person. Grinding may be under any suitable conditions. Grinding may continue for any suitable time period to achieve a desired granule size. For example, a suitable time period may be between 1 and 10 minutes, between 10 and 15 minutes, between 15 and 20 minutes. Suitably, the time period for grinding may depend on the machinery used. Suitably, the time period required to achieve a desired granule size may be dependant on batch size. Suitably, the time period required may vary depending on whether the granular food ingredient is made in a manufacturing scale plant, a commercial kitchen or a smaller scale kitchen such as a restaurant. Merely by way of example, grinding may be carried out using a granulator, grinder, a mill e.g. a hammer mill, a food processor, pestle and mortar, a blender, a mixer, a mincer, a grater, a shredder. Suitably, the skilled person would have the required skill and knowledge to determine an appropriate length of time required to achieve a desired granule size depending on batch size and machinery used.

The term “mixing” as used herein refers to combining a mucilaginous hydrocolloid, a mannan based hydrocolloid, insoluble fibre, water and egg white (of the seventh aspect) or binding agent (of the sixth aspect) and optionally cellulose derivative and other ingredients until the ingredients are substantially uniformly distributed.

Mixing may be under any suitable conditions. In an embodiment, high shear or high dispersal conditions may be used, for example at a rate of 3000 RPM or more, 4000 RPM or more, or 5000 RPM or more. Mixing may continue for any suitable time period to achieve uniform distribution. A suitable time period may for example be between 1 and 30 seconds. More suitably, mixing may be between 15 and 30 seconds. In an embodiment, mixing continues until the first mixture has reached a viscosity of approximately 40,000 centipoise (cP).

In step ii) of the third aspect, the first mixture and egg white are combined to form a liquid mixture. In an embodiment of the third aspect of the invention, combining may be performed by blending, stirring or folding. Blending, stirring or folding may continue until the liquid mixture reaches a viscosity of approximately 25,000 cP. In an embodiment where step i) and step ii) are combined into a single step, blending, stirring or folding of a mucilaginous hydrocolloid, mannan-based hydrocolloid, insoluble fibre, egg white, water, and optionally the texture enhancer may continue until the liquid mixture reaches a viscosity of approximately 25,000 cP.

The liquid mixture may be aerated. Aerating the liquid mixture reduces its specific gravity. Suitably, aerating may reduce the specific gravity of the liquid mixture from between 0.7-0.9 to 0.4-0.6. Although there are various methods by which the liquid mixture may be aerated, merely by way of example, the liquid mixture may be aerated by mixing. A Shufflemixer is an example of a mixer suitable for aerating the liquid mixture.

The combining of the first mixture with the binding agent or the egg white may last any suitable period of time, and may in some embodiments as mentioned above, be a continuous process.

In an embodiment of a batch process of the third aspect, combining may continue for a minimum period of time to achieve uniform distribution of the first mixture and egg white foam whilst avoiding air loss or loss of texture of the liquid mixture obtained. In a batch process, a suitable time period for combination may be between 10 and 60 seconds.

In an embodiment where step i) and step ii) of the third aspect of the invention are carried out in a single step, the mucilaginous hydrocolloid, mannan-based hydrocolloid, insoluble fibre, water and egg white are mixed together. In such embodiments, mixing may last any suitable period of time, and may in some embodiments as mentioned above, be a continuous process. In a batch process, mixing may continue for a minimum period of time to achieve uniform distribution of the mucilaginous hydrocolloid, mannan-based hydrocolloid, insoluble fibre, water and binding agent or egg white in the liquid mixture. In a batch process, a suitable time period for mixing may be between 10 and 600 seconds.

In a suitable embodiment, the liquid mixture may be allowed to rest prior to commencement of step iii) of the method of the third aspect. Resting may occur at any suitable temperature, for example room temperature or refrigerated at a temperature between 2° C. and 20° C. Resting may last up to 1 hour, up to 2 hours, up to 3 hours, up to 4 hours, up to 5 hours, up to 10 hours. In an embodiment, resting may last up to 3 hours.

Applying the liquid mixture to a baking tray may be performed in any suitable way, typically depending upon the desired form of the final food ingredient. For example, liquid mixture may be spread onto a baking tray, in a uniform or non-uniform manner, or may be applied in discrete portions to a baking tray. The term “spreading” as used herein, refers to placing a thin layer of the liquid mixture onto a baking tray. The thickness of the spread liquid mixture may vary. For example, the layer of liquid mixture may be approximately between 0.5 mm and 1 mm thick, between 1 mm and 5 mm thick, 5 mm and 20 mm thick.

The term “baking tray” as used herein, refers to any container or surface on which the food ingredient may be heated. Merely by way of example, a baking tray may be: a baking tin, a baking sheet, or a baking mould. The surface area of the “baking tray” may be lined with a suitable non-stick coating such as Polytetrafluoroethylene (PTFE).

In step iv) of the method of the third aspect of the invention, the liquid mixture is heated to remove water therefrom, to provide a substantially dehydrated food ingredient. Heating may be in the form of baking or dehydration, or indeed any other suitable method.

The term “dehydrating” as used herein, refers to gradual removal of water content from the liquid mixture, typically at a low temperature without cooking the ingredients of the liquid mixture. Dehydrating may comprise the removal of moist air, and the replacement with fresh air. Dehydrating may last for any duration from 30 minutes to 12 hours, more suitably for any duration from 30 minutes to 4 hrs, most suitably for any duration from 30 minutes to 2.5 hours. Dehydrating may occur at a temperature between 80° C. and 200° C., preferably between 90° C. and 150° C., more preferably between 135° C. and 140° C. Alternatively, removal of water from the liquid mixture may be achieved by baking, during which the liquid mixture is heated over a shorter period of time at a temperature of between 150° C. and 200° C.

In a suitable embodiment, heating of the liquid mixture may be achieved through the use of a baking oven. Alternatively, heating of the liquid mixture may be achieved through the use of a dehydrator. Other methods suitable for heating the liquid mixture will be known to the skilled person.

In a suitable embodiment, heating may last until 80%, 85%, 90%, 95% or more of water, has been removed from the liquid mixture. In a suitable embodiment, drying of the liquid may continue until the substantially dehydrated food ingredient of step iv) comprising 15%, 14%, 13%, 12%, 11%, 10%, 9%, 8%, 7%, 6%, 5%, 4%, 3%, 2% or 1% or less of water is formed.

Suitably, the product is not rehydrated prior to grinding.

Flavourings and enhancers may be added at any suitable step of the process, including for example at one or more of the following stages: in formation of the first mixture; during egg whisking; during formation of the liquid mixture; after resting of the liquid mixture; immediately prior to heating; after heating; prior to grinding; after grinding; or prior to packaging. By “during” is meant immediately prior to, in the process of, or immediately after the referenced step.

The method of the invention may further comprise packaging of the food ingredient of the invention. The term “packaging” as used herein, refers to placing the food ingredient in a sealable container. Merely by way of example, a sealable container may be a box (for example a plastic or cardboard box), a bag (for example a plastic bag, paper bag or foil bag) or a pouch (for example a plastic pouch or retort pouch), or a bottle or flask. Other suitable means for packaging will be known to the skilled person.

In an embodiment, the method of the invention may further comprise a step of sterilising the food ingredient of the invention. Suitably, the food ingredient may be sterilised in the packaging. Sterilisation of the food ingredient may be obtained by any suitable method which will allow the ingredient to have a long shelf life. By “long shelf life” it is meant that the ingredient will remain fit for consumption, if stored appropriately, for at least 3, 6, 9, 12, 16, 20, 24 months or longer from the sterilisation of the food ingredient. Appropriated storage includes keeping the food ingredient in an airtight packaging until the food ingredient is to be consumed.

Various methods of sterilisation will be known to the skilled person. Suitably, the food ingredients of the invention may be sterilised using methods selected from the group consisting of: retort sterilisation, microwave sterilisation, radio wave sterilisation, pasteurisation, and ultra-heat treatment (UHT). Preferably, the food ingredients of the invention is sterilised by retort sterilisation.

In a suitable embodiment, the food ingredient of the invention and/or the culinary mix of the second aspect may be sterilised before packaging or after packaging. In a suitable embodiment, the food ingredient or culinary mix may be sterile and packaged.

It will be appreciated that when the food ingredient is sterilised in the packaging, the packaging must be able to withstand the conditions of the sterilisation process. Thus, for example, when the food ingredient is sterilised by retort, the packaging must be able to withstand heat and pressure of the retort sterilisation process. Suitably, when the food ingredient is sterilised by retort, it may be packaged in a retort pouch.

In an embodiment of the third aspect, the present invention provides a method of making a granular food ingredient, the method comprising the steps of:
i) mixing a mucilaginous hydrocolloid, a mannan-based hydrocolloid, insoluble fibre, egg white and water to provide a liquid mixture;
ii) optionally, applying the liquid mixture onto a baking sheet;
iii) drying the mixture to remove water and provide a substantially dehydrated food product and
i) grinding the substantially dehydrated food product of step iii) to create a substantially dehydrated granular food ingredient
ii) sterilising the substantially dehydrated granular food ingredient.

A method comprising the step of sterilising the granular food ingredient, gives rise to an embodiment of the invention wherein the food granular food ingredient of the first aspect which has a long shelf life.

It will be the appreciated that the percentages mentioned throughout this specification refer to the food ingredients, i.e. the granular food ingredient of the first aspect. The percentages do not include any additional ingredients such as flavourings or food enhancers that may be added to the food ingredients.

The invention is not restricted to the details of any forgoing embodiments. The embodiments of each aspect apply to the other aspects of the invention, mutatis mutandis.

Throughout the description and claims of this specification, the words “comprise” and “contain” and variations of them mean “including but not limited to”, and they are not intended to (and do not) exclude other components. Throughout the description and claims of this specification, the singular encompasses the plural unless the context otherwise requires. In particular, where the indefinite article is used, the specification is to be understood as contemplating plurality as well as singularity, unless the context requires otherwise.

Features described in conjunction with a particular embodiment of the invention are to be understood to be applicable to any other embodiment described herein unless incompatible therewith. All of the features disclosed in this specification (including any accompanying claims and drawings) may be combined in any combination, except combinations where at least some of such features and/or steps are mutually exclusive. The invention extends to any novel one, or any novel combination, of the features disclosed in this specification (including any accompanying claims).

### EXAMPLE 1

### A Dehydrated Food Ingredient

A liquid mixture of 376 grams was prepared using the following ingredients:
Psyllium—2 grams (accounting for ˜0.5% of the liquid mixture),
Konjac—2 grams (accounting for ˜0.5% of the liquid mixture),
Egg white—50 ml (accounting for ˜13.5% of the liquid mixture)
Wheat fibre—16 grams (accounting for ˜4% of the liquid mixture),
Water—300 grams (accounting for ˜80% of the liquid mixture), and optionally
Hydroxypropyl methylcellulose (HPMC)—˜5 grams (accounting for 1.5% of the liquid mixture), and optionally
Salt—1 grams (accounting for ˜0.5% of the liquid mixture)

Psyllium, konjac, wheat fibre, HPMC, salt and water were mixed under high dispersal conditions until the mixture reached a viscosity of approximately 40,000 cP. Separately, the egg white was whisked until stiff peaks were obtained, upon which the whisked egg white and mixture of water and dry ingredients were combined by blending until a uniform blended mixture with a viscosity of 25,000 cP was obtained.

The blended mix was allowed to rest for 5 minutes at room temperature before it was transferred to a PTFE lined baking tray and dehydrated in an oven at a temperature of 95° C. for 8 hours. The dehydration process removed approximately 95% of the water initially found in the liquid mixture. The dehydrated product was then ground to a fine powder resembling flour in a granulator.

### EXAMPLE 2

### A Dehydrated Food Ingredient

Psyllium—1.5 grams (accounting for ˜0.35% of the liquid mixture),

Konjac—1.5 grams (accounting for ˜0.35% of the liquid mixture),

Egg white powder—12.5 grams (accounting for ˜3% of the liquid mixture)

Water for reconstituting the egg white powder—87.5 grams (accounting for ˜20.5% of the liquid mixture; together the egg white powder and water form egg white, which accounts for ˜203.5% of the liquid mixture)

Wheat fibre—16 grams (accounting for ˜4% of the liquid mixture),

Water—300 grams (accounting for ˜70% of the liquid mixture), and optionally

Hydroxypropyl methylcellulose (HPMC)—˜5 grams (accounting for 1% of the liquid mixture), and optionally

Salt—1 grams (accounting for ˜0.25% of the liquid mixture)

Psyllium, konjac, wheat fibre, HPMC, egg white, salt and water were mixed under high dispersal conditions until the mixture was in the form of a foamy batter.

The blended mix was aerated before 175 grams of the mix were transferred to a baking tray and dehydrated in an oven at a temperature of approximately 135° C. until approximately 95% of the water initially found in the liquid mixture was removed. The dry product was ground to a fine powder resembling flour in a granulator.

The flour was used to produce a cake, by combining about 40 g flour produced as above, about 110 g sweetener, and about 20 egg white powder. In addition, flavourings, colouring, gelling agents, preservatives were added. Water was added to the mixture, and the batter was baked until cooked through.

### EXAMPLE 3

Psyllium—0.8 grams,

Konjac—0.8 grams,

Egg white powder—3.33 grams

Water—1 gram

Wheat fibre—8.53 grams

Hydroxypropyl methylcellulose (HPMC)—2.67 grams

Salt—1 grams

The 17.5 gram dry product was ground to a fine powder resembling flour in a granulator.

The flour was used to produce a cake, by combining about 40 g flour produced as above, about 110 g sweetener, and about 20 egg white powder. In addition, flavourings, colouring, gelling agents, preservatives were added. Water was added to the mixture, and the batter was baked until cooked through.

1. A substantially dehydrated granular food ingredient comprising a mucilaginous hydrocolloid, a mannan-based hydrocolloid, egg white, insoluble fibre and water.

2. A substantially dehydrated granular food ingredient according to claim 1 comprising 1%-25% by weight of a mucilaginous hydrocolloid, 1%-25% by weight of a mannan-based hydrocolloid, 5%-50% by weight of egg white, and 30%-90% by weight of insoluble fibre.

3. A substantially dehydrated granular food ingredient according to claim 1 comprising between 5%-40% by weight of a texture enhancer.

4. A substantially dehydrated granular food ingredient according to claim 1 comprising a population of granules or particles having a particle size of about 5 μm to 5 mm.

5. A substantially dehydrated granular food ingredient according to claim 1 wherein the granular food ingredient is a flour or breadcrumb substitute, or comprises a population of granules or particles which are in the form of a crumb.

6. A substantially dehydrated granular food ingredient according to claim 1 wherein the granular food ingredient is low in fat.

7. A substantially dehydrated granular food ingredient according to claim 1 wherein the egg white is natural egg white from an egg, is an egg white powder, or an egg white powder that is reconstituted in water.

8. A substantially dehydrated granular food ingredient according to claim 1 which is sterilised and/or packaged.

9. A substantially dehydrated granular food ingredient according to claim 1 wherein the granular food ingredient has a long shelf life.

10. A culinary mix comprising a granular food ingredient according to claim 1.

11. A culinary mix according to claim 10, further comprising one or more ingredients selected from the group consisting of sugar, artificial sweetener, cocoa, flavouring, colouring, fats, baking powder, salt and egg.

12. A culinary mix according to claim 10 further comprising a natural or artificial sweetener, a binding agent and wheat.

13. A culinary mix according to any one of claim 10 comprising 50-60% sweetener, 30-45% fine crumb or flour, 15-25% binding agent, and 3-10% wheat.

14. A culinary mix according to any one of claim 10 for preparing a brownie or a cake.

15. A method of making a granular food ingredient according to claim 1 the method comprising the steps of:
i) mixing a mucilaginous hydrocolloid, a mannan-based hydrocolloid, insoluble fibre, and water to provide a first mixture;
ii) combining the first mixture with egg white to provide a liquid mixture;
iii) optionally, applying the liquid mixture onto a baking sheet;
iv) drying the mixture to remove water and provide a substantially dehydrated food product and
v) grinding the substantially dehydrated food product of step iv) to create a granular food ingredient.

16. A method according to claim 15 further comprising a step of sterilising and/or packaging the food ingredient.

17. A substantially dehydrated granular food ingredient according to claim 2 further comprising 0.1%-10% by weight of water.

18. A substantially dehydrated granular food ingredient according to claim 6 comprising less than 3% by weight of fat.

19. A culinary mix according to claim 13 further comprising one or more ingredients selected from the group consisting of a gelling agent, flavourings, preservatives, colourings, rising agents, and texture enhancers.
